(19) United States
(12) Patent Application Publication
(10) Pub. No.: US 2005/0109428 A1
(43) Pub. Date: May 26, 2005

(54) Transmission chain

(75) Inventor: Alexandre Charton, Arras (FR)

Correspondence Address: MICHAEL BEST & FRIEDRICH, LLP, 100 E WISCONSIN AVENUE, MILWAUKEE, WI, 53202, US

(73) Assignee: RENOLD PLC, Manchester (GB)

(21) Appl. No.: 10/959,815

(22) Filed: Oct. 6, 2004

(30) Foreign Application Priority Data
Oct. 7, 2003 (GB) GB 0323418.4

(51) Int. Cl. F16G 13/02; C23C 8/22

(52) U.S. Cl. 148/319

(57) ABSTRACT

An inverted tooth transmission chain with articulating link plates has improved wear resistance and life expectancy. The articulating link plates are blanked from steel having an aluminium content of 0.01% to 0.08% by weight and a grain size number of at least 8 ASTM. The link plates are then carburised by heating them to a temperature in the range 800° C. to 1000° C. for a period of between 10 to 60 minutes in a conventional carburising atmosphere including, for example, methane or propane. The link plates are then quenched or austempered in an oil or salt bath. The final hardness of the carburised link plate is in the region of 600 to 700 Hv (Vickers hardness value).

The present invention relates to a transmission chain and more particularly to an inverted tooth silent chain that is used typically as a timing chain in an internal combustion engine of a vehicle.

An inverted tooth timing chain comprises a plurality of interleaved link plates interconnected by pins. Outer link plates, commonly known as “guide” links are fixed relative to the pin and the inner link plates are connected such that they articulate on the pins. At least the inner link plates have depending teeth that mate with the teeth on the periphery of drive and driven sprockets.

The timing chain passes around a drive sprocket attached to the crankshaft of an internal combustion engine and around a driven sprocket that is attached to the camshaft so that rotary motion of the crankshaft is transmitted synchronously to the camshaft. The synchronous rotation of the sprockets is important to ensure that the movement of valves on the camshaft is in an accurate timed relationship with the movement of the pistons on the crankshaft.

In use, the individual link plates of such chains are subjected to rubbing contact with other link plates or the pins of the chain and are therefore prone to wear. Wear in chains leads to chain elongation, inefficient power transmission or unmeshing of the chain from the sprockets. This is particularly undesirable in timing chains as the camshaft may rotate several degrees out of alignment with the crankshaft and render the engine inefficient or inoperative.

It is well known to subject the components of chains to heat treatment to improve chain endurance and to reduce the tendency to wear. The articulating link plates of silent chains are sometimes austempered or case-hardened to produce a hard surface layer on the steel plates. Case-hardening is detrimental to the ductility of the plates and it is necessary to adopt additional manufacturing processes such as heat treatment or the application of further material to compensate for the loss of ductility. This is reflected in U.S. Pat. No. 1,551,764 which describes a method of manufacturing link plates of a power transmission chain. The link plates are masked with a coating that prevents access to carbon during a subsequent carburising process so that predetermined areas of the chain are not hardened by the carburising atmosphere and are therefore not made brittle and prone to failure in use. US patent application no. 2003-0070737 describes chain link plates that are plastically deformed by compression and tension deformation after case-hardening to improve the endurance of the chain.

It is an object of the present invention to provide for a transmission chain in which the resistance to wear is improved without loss of ductility.

According to a first aspect of the present invention there is provided a transmission chain having a plurality of guide links interleaved with articulating links, the links being interconnected by pins, at least some of the articulating link plates being formed from a steel having a refined grain structure with a grain size number of at least 8 ASTM.

Preferably the articulating link plates have been hardened by a carburising treatment to obtain a surface hardness of at least 600 Hv and more preferably at least 650 Hv.

The link plates are ideally formed by blanking.

Preferably the grain size number is at least 9 ASTM.

The steel may have an aluminium content ranging from 0.01 to 0.08% by weight.

The carbon content of the steel may be in the range 0.4% to 0.6% by weight. The surface layer of the steel after carburising has a carbon content in the range 0.7% to 1.0% by weight.

Preferably the plates have an austenitic grain size number of at least 8 ASTM.

Preferably the edges of the plates are finished to have a radius of at least 50 μm.

According to a second aspect of the present invention there is provided a method for producing a steel link plate for a silent chain comprising the steps refining the grain structure of the steel so that it has a grain size number of at least 8 ASTM, forming the plate from the steel and then carburising the plate to obtain a surface hardness of at least 600 Hv.

Preferably the plates are blanked from the steel.

A specific embodiment of the present invention will now be described, by way of example only, with reference to the accompanying drawings in which:

FIG. 1 is a side view of an inverted tooth timing chain in accordance with the present invention, the chain being shown partially cut-away and with centre lines represented;

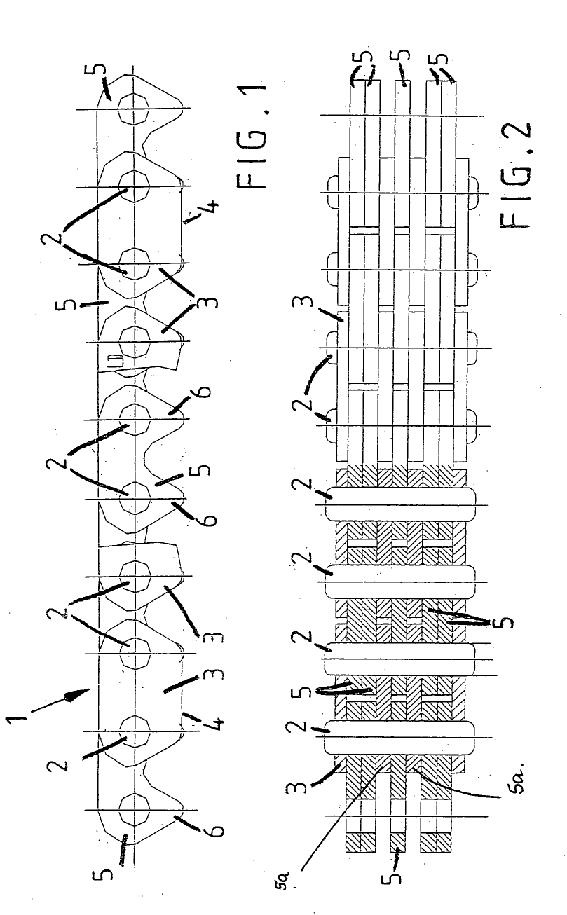

FIG. 2 is plan view of the chain of FIG. 1, shown in partial section; and

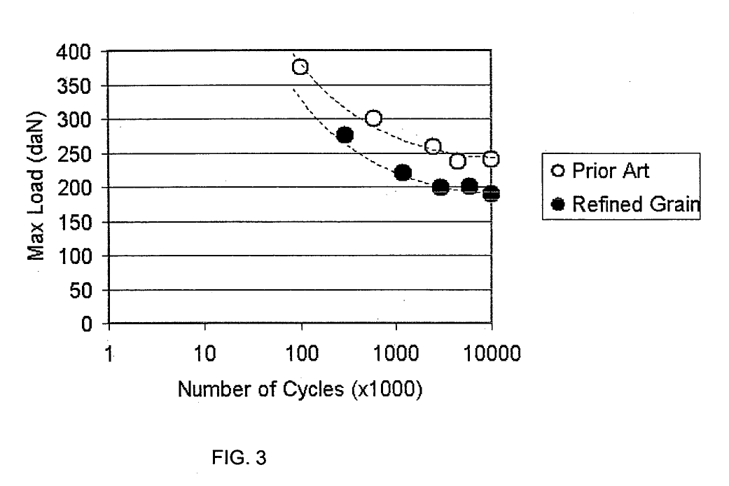

FIG. 3 is a graph showing the fatigue performance of a silent chain according to the present invention in comparison to a standard prior art silent chain

Referring now to FIG. 1 of the drawings, an inverted tooth timing chain comprises a plurality of interleaved chain link plates 1 interconnected by a plurality of pins 2. The outer link plates 3 have a flat underside 4 and fixed to the pin whereas the inner link plates 5 have a toothed formation 6 for engagement with corresponding teeth on a drive sprocket (not shown) and are free to articulate on the pin. Intermediate guide link plates 5a disposed between the articulating plates and in line with the outer link plates are also fixed to the pins.

The movement of the chain into engagement with the sprocket and then movement with the sprocket imparts rubbing contact between the inner link plates 5 and the outer surface of the pins 2 and between overlapping portions of adjacent link plates 3, 5, 5a.

The link plates of the inverted tooth silent chain are produced from a steel having a carbon content of around 0.4% to 0.6% by weight. The steel and the treatment applied to it before or during the production of the chain link plates is such that the chain has good wear resistance and does not suffer from a loss in ductility. Examples of the production process are described below. These are generally applied only to the inner articulating link plates are these are the most prone to wear but they may additionally be applied to other link plates.

### EXAMPLE 1

Steel having a carbon content of 0.49% by weight and an aluminium content of 0.004% by weight is cold-rolled with a degree of working (kneading rate) of approximately 60% to achieve a ferritic grain size having a number of at least 8 ASTM (American Society for Testing and Materials) Standard E112. The aluminium forms aluminium nitride and helps to control the grain size.

The composition of the steel in the chain of the present invention compared to two standard silent chains (one made from steel according to the SAE 1055 standard and the other according to DIN Ck45 standard) is as follows (measurements given in % weight).

| | STANDARD | STANDARD | PRESENT |
|---|---|---|---|
| ELEMENT | CHAIN (SAE 1055) | CHAIN (DIN Ck45) | INVENTION |
| Carbon | 0.59 | 0.49 | 0.49 |
| Manganese | 0.76 | 0.69 | 0.69 |
| Silicon | 0.22 | 0.24 | 0.24 |
| Phosphorous | 0.013 | 0.008 | 0.008 |
| Sulphur | 0.013 | 0.0005 | 0.005 |
| Nickel | 0.012 | 0.04 | 0.04 |
| Chromium | 0.053 | 0.24 | 0.24 |
| Aluminium | <0.005 | 0.004 | 0.01-0.08 |

It will be appreciated that the only significant difference to the composition of the raw steel of the present invention compared to the DIN standard is in the aluminium content which is in the region of 10 times as much.

The silent chain link plates are blanked from the steel using a known technique and then carburised by heating them to a temperature of approximately 880° C. (but it is contemplated that the temperature can be anywhere in the range 800° C. to 1000° C.) for a period of around 20 minutes (although anywhere in the region of 10 to 60 minutes is contemplated) in a conventional carburising atmosphere including, for example, methane or propane. The link plates are then quenched or austempered in an oil or salt bath for a predetermined period. The final hardness of the surface layer of carburised link plate is in the region of 600 to 700 Hv (Vickers hardness value) with the carbon content in the hard surface layer being in the range 0.7% to 1.0%. It will be appreciated that the presence of martensite and bainite in the steel after quenching makes it impossible to measure the grain size. However, using the MacQuaid-Ehn method the austenitic grain size number of the plates after carburising is at least 8 ASTM.

An inverted tooth chain having link plates treated in accordance with the above example was found to be wear resistant and to have improved resistance to fatigue and therefore an improved life expectancy.

A graph illustrating the comparative fatigue results between DIN ck45 steel standard silent chain and the refined grain steel of the present invention is shown in FIG. 3.

### EXAMPLE 2

The chain link plates are blanked from a sheet of cold-worked steel of the composition defined above in Example 1 and are then annealed at a temperature of 850° C. for a period of 3 minutes to refine the grain size. The plates are then carburised as in Example 1. The resulting link plates have an austenitic grain size number of at least 8 ASTM (American Society for Testing and Materials) Standard E112.

In both examples the peripheral right-angled edges of each link plate and the area of the plate around the pin holes can be finished by burnishing or otherwise finishing the edges with a suitable abrasive to achieve a radius of at least 50 μm.

It will be appreciated that although the present invention has been described above in relation to inverted tooth chains, the same treatment can be applied to other transmission chains such as a roller chain. The treatment may be applied to not only the plates of a roller chain but also to the bushes and rollers.

1. A transmission chain having a plurality of guide links interleaved with articulating links, the links being interconnected by pins, at least some of the articulating link plates being formed from a steel having a refined grain structure with a grain size number of at least 8 ASTM.

2. A transmission chain according to claim 1, wherein the articulating link plates have been hardened by a carburising treatment to obtain a surface hardness of at least 600 Hv.

3. A transmission chain according to claim 2, wherein the surface hardness is at least 650 Hv.

4. A transmission chain according to claim 2, wherein the plates have an austenitic grain size number of at least 8 ASTM.

5. A transmission chain according to claim 2, wherein the carbon content of the surface layer of the carburised plates is in the range 0.7% to 1.0% by weight.

6. A transmission chain according to claim 1, wherein the link plates are blanked.

7. A transmission chain according to claim 1, wherein the grain size number is at least 9 ASTM.

8. A transmission chain according to claim 1, wherein the steel has an aluminum content ranging from 0.01 to 0.08% by weight.

9. A transmission chain according to claim 1, wherein the carbon content of the main body of the steel is in the range 0.4% to 0.6%.

10. A transmission chain according to claim 1, wherein the edges of the plates are finished to have a radius of at least 50 μm.

11. A transmission chain according to claim 1, wherein the steel has been cold-rolled with a kneading rate of 60%.

12. A transmission chain according to claim 1, wherein at least the articulating link plates are of the inverted tooth type.

13. A transmission chain according to any preceding claim claim 1 made from carbon steel.

14. A method for producing a steel link plate for a silent chain comprising the steps refining the grain structure of the steel so that it has a grain size number of at least 8 ASTM, forming the plate from the steel and then carburising the plate to obtain a surface hardness of at least 600 Hv.

15. A method according to claim 14, wherein the plates are blanked from the steel.

16. A method according to claim 14, wherein the steel is cold-rolled to refine the grain structure.

17. A method according to claim 16, wherein the steel is cold-rolled with a kneading rate of 60%.

18. A method according to claim 14, wherein the steel is a carbon steel.

19. (canceled)
